(19) United States
(12) Patent Application Publication
(10) Pub. No.: US 2004/0267444 A1
(43) Pub. Date: Dec. 30, 2004

(54) Hybrid intertial navigation unit with improved altitude integrity

(76) Inventors: Jacques Coatantiec, Bourg Les Valence (FR); Sebastien Juillaguet, Bourg De Peage (FR); Jacques Coatantiec, Bourg Les Valence (FR); Sebastien Juillaguet, Bourg De Peage (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/494,467

(22) PCT Filed: Nov. 26, 2002
(86) PCT No.: PCT/FR02/04045

(30) Foreign Application Priority Data
Nov. 27, 2001 (FR) 0115318

(51) Int. Cl. G05D 1/00; G06F 17/00

(52) U.S. Cl. 701/202; 701/4; 701/211; 701/220

(57) ABSTRACT

To improve the accuracy of altitude measurement, the inertial unit (C_INERT) is associated with a radiosonde supplying a height (HAUT_ALT) of the aircraft relative to the ground and a terrain database (DTED) supplying an altitude of the ground (ALT_GND) at the horizontal position (POS_HOR_HYB) of the aircraft delivered by the inertial unit. The inertial unit supplies an altitude (ALT_HYB) which is corrected based on the values supplied by the radiosonde and the terrain database. A radius of protection (RPalt_hyb_cor) of the altitude thus corrected is computed. For this computation of protection radius, particular use is made of a computation of the altitude dispersion of the terrain around the horizontal position of the aircraft, in a circle delimited on the basis of the radius of protection of the horizontal position (RPpos_hor_hyb), supplied by the inertial unit at the same time as the horizontal position.

The invention relates to navigation aid and pilot aid instruments, and in particular those that are intended for air navigation in which the accuracy constraints on position and velocity are high and in which it is necessary to know at all times the integrity of the information given by the position and velocity measurement instruments.

The use of inertial navigation units in aircraft is very conventional today. These units use accelerometers to determine accelerations along axes defined relative to the aircraft, gyrometers to determine velocities of angular rotation relative to axes also defined relative to the aircraft and, where necessary, other sensors such as a baro-altimeter. The orientation of the aircraft at a given moment is determined by integration of the gyrometric measurements; the velocity components of the aircraft are determined in this terrestrial reference frame by integration of the accelerometric measurements, which may be referred to a terrestrial reference frame outside the aircraft based on the knowledge of the orientation of the aircraft. Geographic positions are determined by integration of the velocities.

The measurement sensors are however imperfect and exhibit intrinsic errors or measurement bias, which may furthermore vary during navigation. In addition, they are subject to measurement noise, in the sense that random variations with no correspondence to the variations of the magnitude measured are superimposed on the wanted signal, representing the physical magnitude sought. The measurement electric signals are moreover processed by electronic circuits which themselves introduce noise.

The measurement bias and noise are all the more obstructive when the position computations made based on the measurement results of the sensors involve integrations. Integration engenders a drift of the measured value, a drift which increases progressively over time when the integrated value is biased at the beginning. A double integration (integral of acceleration to give the velocity then integral of velocity to give the position) further increases this drift in considerable proportions.

In summary, inertial units are very accurate over a very short period but, due to the systematic time-related integration of the bias, are subject to a significant drift which means they have to be periodically reset based on other position (or velocity) information.

With regard to the altitude of the aircraft, they may be reset based on a baro-altimeter which measures the altitude as a function of measured pressure data and of local meteorological indications. The inertial unit is then a “baro-inertial” unit which hybridizes the inertial measurements and the barometric altitude measurements. However, the barometric altitude measurements are not very reliable, particularly when there are temperature inversion phenomena in the atmospheric layers.

More recently, inertial units have begun to be reset based on satellite positioning receivers on board the aircraft and gleaning position and velocity information, in a terrestrial reference frame, from the signals they receive from the satellites.

Hybrid units are thus produced taking advantage of both the excellent quality of very short term measurement of the inertial units (measurement sustaining very little noise) and of the high geographic positional accuracy offered by the satellite positioning systems.

The hybridization of the two systems, the inertial system and the satellite positioning system, is usually achieved by the use of filtering algorithms, usually known by the name of Kalman filtering. This is a digital filtering carried out in the course of the computations which are used to determine a position known as the “hybrid position” based on information originating from the inertial unit and on information given by the satellite positioning receiver.

If the satellite positioning measurements are lost or deteriorate (it should be remembered that they may easily be lost because the signal emitted by the satellites is extremely weak and they may be incorrect, for example due to the presence of multi paths between a satellite and the receiver), Kalman filtering makes it possible to continue to compute a hybrid position which is of the inertial type (that is to say similar to that which would be supplied by an inertial unit alone) but which has the drift errors of the unit corrected; specifically, Kalman filtering constantly computes these errors and may use errors identified just before the loss of the satellite signals to continue correcting the unit after this loss up to the time when the satellite signals become available again.

However, the accuracy and reliability of hybrid inertial units corrected by satellite positioning receivers is inadequate for certain applications, such as automatic landing of aircraft.

Altitude measurements are particularly critical during the landing phase, whether it is in a preliminary phase of descending to a few hundred meters above the ground (typically to break through a cloud layer obstructing visibility), or a final runway landing phase. In the first case, the requirement is for an altitude accuracy of approximately 50 meters, which satellite positioning receivers have difficulty supplying in a sufficiently reliable manner. In the second case, the requirement is for an altitude accuracy of the order of 5 meters, and for that the satellite positioning receiver is assisted by a local ground station to make it function on a differential basis (DGPS system), but, despite this assistance, the receivers have difficulty supplying the expected 5 meters accuracy.

An aim of the present invention is therefore to improve the hybrid inertial navigation units by adding supplementary means to improve the accuracy of the altitude measurements supplied.

More generally, the desire is to improve not only the accuracy of the altitude measurement, but also knowledge of the accuracy associated with a measurement, given that this accuracy does not have a fixed value (it depends on very many parameters) and that it may be useful in enabling decisions to be taken. For example, when there is a drop below a certain accuracy threshold, the aircraft's onboard computer may trigger an alarm intended to prevent proceeding with a landing.

This accuracy is defined by a confidence value that can be attributed to the measurement made, this confidence value being expressed in the form of a protection radius, in the presence or in the absence of failure. The protection radius is a distance value around a (horizontally or vertically) measured position, such that it may be considered that the exact position is effectively situated in this radius around the measurement performed, with a chosen degree of confidence, that is to say with a determined maximum probability of error.

According to the invention, the proposal is for an onboard navigation aid system in an aircraft, comprising an inertial navigation unit supplying a horizontal position and an altitude in a terrestrial reference frame, and comprising at least one means (in principle a radiosonde) for supplying a measurement of the height of the aircraft relative to the ground, a terrain database supplying an altitude of the ground corresponding to the horizontal position delivered by the inertial unit, and means for correcting the altitude supplied by the inertial unit by using the data originating from the means for supplying the height and the terrain database, characterized in that it also comprises means for supplying a radius of protection associated with the horizontal position supplied by the inertial unit and computing means supplying a radius of protection associated with the corrected altitude, the latter computing means comprising means for computing a dispersion of the altitude of the ground as contained in the terrain database, within a limited zone of terrain centered on the horizontal position supplied by the inertial unit.

The altitude dispersion is computed preferably in a zone the radius of which is defined based on the radius of protection of the horizontal position. Preferably, it is computed in a zone the radius of which is the sum of the radius of protection of the horizontal position and of a value linked to a detection inaccuracy of the means for supplying the height. If the height is supplied by a radiosonde, the value added to the radius of protection is preferably the radius of a circle of radio illumination of the ground by the radiosonde.

The means of computing the radius of protection of the corrected altitude in principle comprise a means of computing a quadratic sum of a standard deviation (Σalt_rad) linked to the computation of the sum of the height relative to the ground (HAUT_RAD) and of the altitude of the ground (ALT_GND) and of a standard deviation (Σalt_hyb) linked to the altitude originating from the inertial unit (ALT_HYB), and a means for computing a standard deviation and a radius of protection of the corrected altitude, based on the quadratic sum computed and averaged over N successive measurement samples.

The standard deviation linked to the computation of the sum of the height relative to the ground and of the altitude of the ground is preferably the quadratic average of several standard deviations including a standard deviation (Σdisp) representing the altitude dispersion of the ground.

The determination of height relative to the ground is preferably performed by a radiosonde. A radiosonde operates like a radar: it transmits high frequency radio signals vertically and measures the time separating the transmission of these signals from the receipt of an echo; knowing the transmitted frequency, it computes the distance separating the aircraft from the ground.

A radiosonde supplies heights that increase in accuracy the closer the aircraft carrying it is to the ground. The accuracy may be of the order of 1%.

To correct the altitude supplied by the inertial unit, matters begin by computing a deviation between this altitude and a altitude determined based both on the height of the aircraft, delivered by the radiosonde, and on the altitude of the ground delivered by the terrain database. In principle, the difference is simply taken between on the one hand the hybrid altitude and on the other hand the sum of the altitude of the ground and the height of the aircraft.

The altitude supplied by the inertial unit could be corrected by purely and simply replacing it with the altitude thus supplied by the radiosonde associated with the terrain database. However, it is preferable to carry out a digital filtering of the deviation measured to compute a correction more appropriate to apply to the altitude supplied by the inertial unit: in fact the value of the deviation is smoothed over several measurements corresponding to several successive values of position and of altitude supplied by the inertial unit.

The smoothing can be carried out by averaging N successive altitude deviations, and the altitude correction fed to the inertial unit is then the sliding average of N successive deviations corresponding to the last N position and altitude measurements.

But the smoothing may also be carried out by a digital filtering loop establishing an altitude correction value by integration of an error signal representing the difference between the altitude deviation observed and the altitude correction made by the loop for a previous measurement.

To carry out the hybridization by computing at the same time an indication of the reliability or accuracy of the measurement, and by improving that reliability relative to what would normally be given by the inertial unit (hybridized or not with a satellite positioning receiver), a terrain database onboard the aircraft will be used in a manner that can be summarized thus: the inertial unit supplies horizontal position data (longitude and latitude) and an altitude. The horizontal position is assigned a protection radius (further mention will be made of the concept of protection radius associated with a given nondetection probability). The inertial unit supplies an altitude together with an associated protection radius which is too great relative to what is required. The association of the radiosonde with the terrain database supplies information together with a standard deviation that can be computed (later mention will be made of this computation). To associate a protection radius with the altitude measurement corrected by the radiosonde and the terrain database, it is preferable to proceed as follows: compute the altitude dispersion of the ground as contained in the database, within a limited zone centered on the horizontal position given by the inertial unit; this dispersion is thereafter associated with an intrinsic accuracy of the terrain database and with an intrinsic accuracy of the radiosonde; the combination of these three accuracy data may be expressed in the form of a standard deviation of altitude measurement by the radiosonde; this standard deviation may be combined with the standard deviation of the altitude supplied by the inertial unit, then averaged over a certain number of samples or filtered, to supply a global standard deviation of the altitude correction fed to the output of the inertial unit and therefore a protection radius associated with the corrected altitude.

In particular, when the altitude correction is computed by averaging or filtering successive measurements of the deviation that exists between the inertial unit on one hand and the radiosonde associated with the terrain database on the other, a global standard deviation of the correction applied can be computed. A protection radius (corresponding to the standard deviation multiplied by a coefficient) may then be associated with the corrected altitude. An alarm may be triggered if the successive standard deviations do not match a pre-established model taking account of the a priori Gaussian nature of the deviations observed.

To determine the altitude dispersion of the ground, which enters into the computation of the radius of protection of the corrected altitude, it will be preferable to measure the altitude deviations in a zone the radius of which is defined based on the protection radius of the horizontal position supplied by the inertial unit. The radius of this zone may also take account of the radius of the zone of ground illuminated by the radiosonde (the spread angle of which may easily reach 45°).

It will be understood that, according to the invention, a terrain database onboard the aircraft is used, but, contrary to what has been feasible in the prior art, this database is not used to improve the integrity of the measurement of horizontal position (which a terrain correlation did in the past), but it is used to improve the integrity of the altitude measurement. This improvement arises not only because use is made of the ground altitude information contained in the database, but use is also made of an altitude dispersion computation in a zone situated around the horizontal position of the aircraft, this zone being defined primarily by the protection radius associated with the horizontal position supplied by the inertial unit.

It will also be noted that the inertial unit, which is improved thanks to the radiosonde associated with a terrain database, may be a simple inertial unit or a baro-inertial unit, or preferably an inertial unit or baro-inertial unit hybridized with a satellite positioning receiver; in this case, the position information which is entered into the terrain database is the hybrid horizontal position supplied by the hybridized unit and the altitude corrected due to the radiosonde is the hybrid altitude.

Other features and advantages of the invention will emerge on reading the detailed description that follows making reference to the appended drawings wherein:

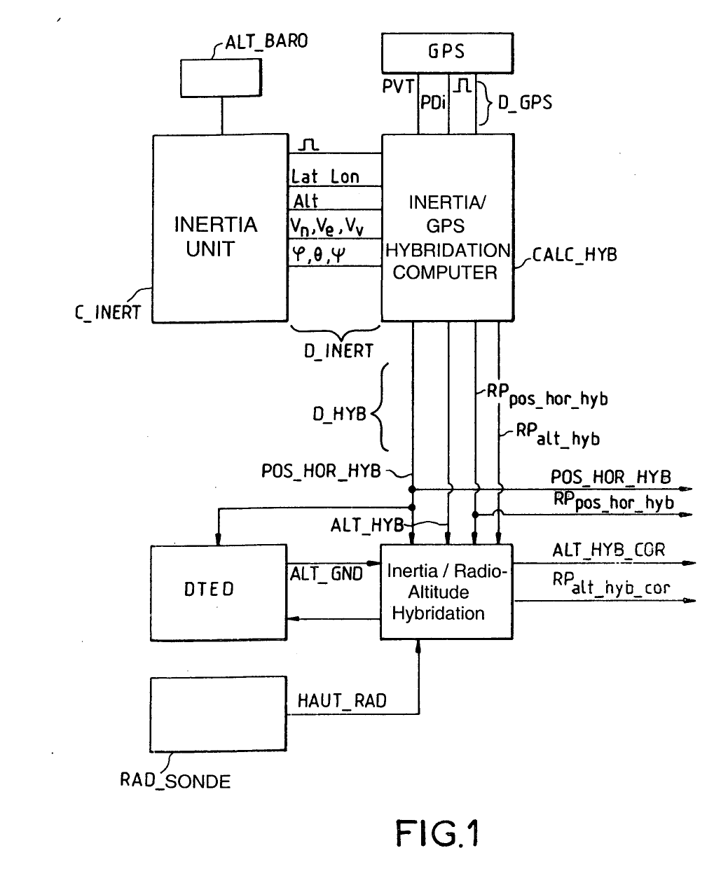

FIG. 1 represents schematically the principle of a hybridized inertial unit which is associated with a radiosonde and an onboard terrain database;

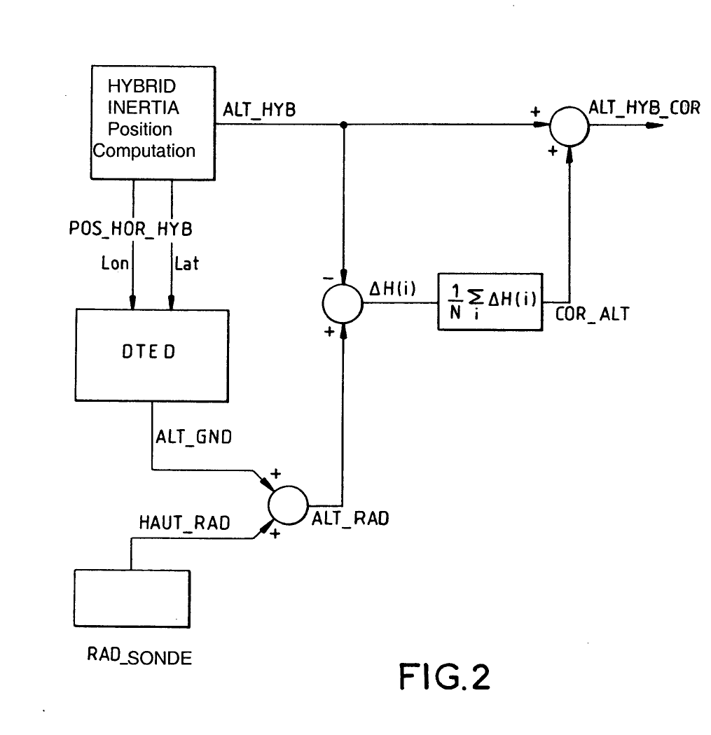

FIG. 2 represents the principle of computing the corrected altitude;

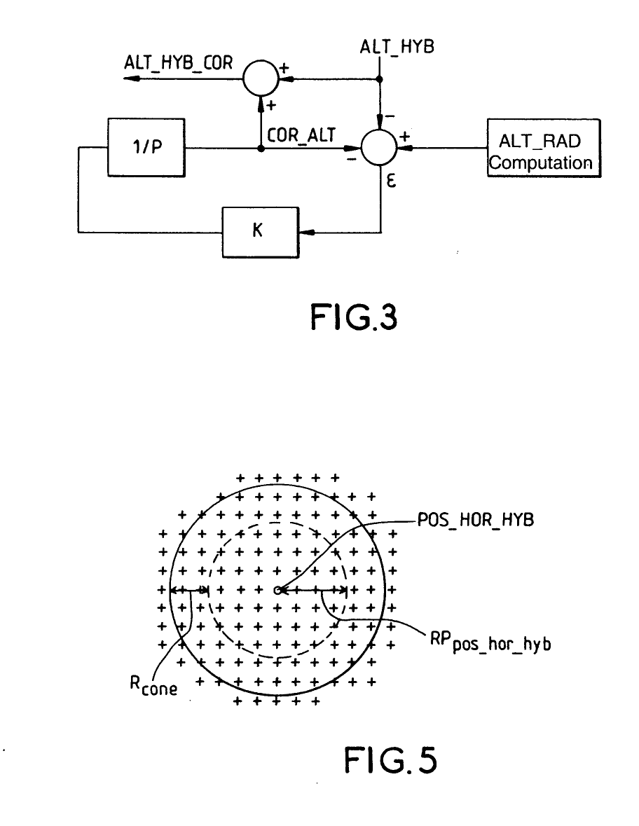

FIG. 3 represents a variant of computing the corrected altitude;

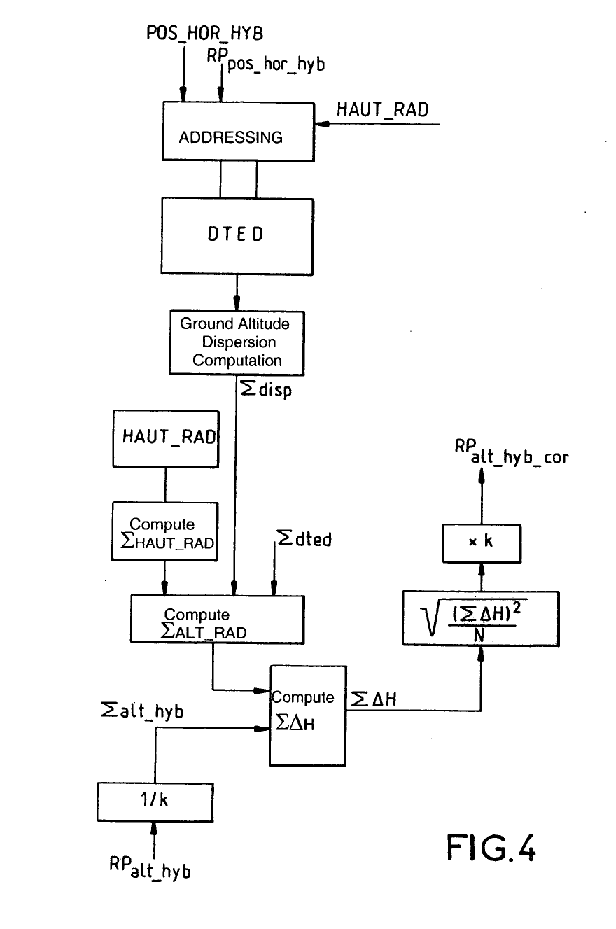

FIG. 4 represents the principle of computing the protection radius of the corrected altitude;

FIG. 5 represents the principle of computing ground attitude dispersion, which enters into the computation of the protection radius of the corrected altitude.

The invention will be described in the case of an inertial unit hybridized with a satellite positioning receiver. The hybridized inertial unit comprises an inertial unit proper, called C_INERT, a satellite positioning receiver, which will hereafter be called a GPS receiver with reference to the most familiar positioning system known as the “Global Positioning System”, and an electronic hybridization computer, CALC_HYB.

The inertial unit C_INERT most frequently consists of

several accelerometers, typically three, with orientations fixed relative to the aircraft, supplying acceleration values along these axes,

several gyrometers, typically three, each having an axis fixed relative to the aircraft and supplying values of velocity of angular rotation about these axes,

a computer which determines digital data of geographic position (Lat, Lon, Alt), geographic velocity (Vn, Ve, Vv), heading, roll and pitch attitudes (φ, θ, Ψ), etc. based on indications supplied by the accelerometers and gyrometers; the computer also supplies a time marking pulse defining the instant at which these data are valid.

All these data, hereinafter called raw inertial data D_INERT, are supplied by the inertial unit to the hybridization computer.

Where appropriate, other sensors may be associated with the unit to refine the computations, such as a barometric altimeter (ALT-BARO). The computer of the inertial unit then uses the information from this or these additional sensors at the same time as the information from the gyrometers and accelerometers.

The GPS receiver conventionally supplies a geographic position in terms of longitude, latitude and altitude, also called the resolved position, also including a time of position measurement. In principle, the receiver also supplies velocities of travel relative to the earth. The combination of this position, this time and this velocity is called the PVT point. A time marking pulse defining the instant of validity of the PVT point is also supplied.

For its operation, the GPS receiver uses a measurement of distances between the receiver and each satellite within sight of the receiver. These distances are in reality pseudo-distances PDᵢ (where i is a satellite number) obtained in the form of signal propagation delays between the satellite numbered i and the receiver along the axis (satellite axis) joining the satellite and the receiver. It is by combining the pseudo-distances on several satellite axes with the knowledge of the satellite positions at a given moment (sent in the form of ephemerides by the satellites themselves) that the resolved position PVT can be computed.

The hybridization between the inertial unit and the GPS receiver may be achieved based on the resolved position and/or the pseudo-distances PDᵢ.

The GPS receiver supplies the hybridization computer CALC_HYB with all these data (and where appropriate other data: ephemerides, signal-to-noise ratios, protection radii specific to the GPS receiver, etc.), designated in the figure as D_GPS (GPS data).

The raw inertial data D_INERT and the GPS data are processed in the hybridization computer to supply hybrid inertial data D_HYB which are a hybrid attitude, a hybrid velocity and a hybrid position. In the hybrid position, the computer supplies a hybrid horizontal position POS_HOR_HYB in the form of a longitude and a latitude in a terrestrial reference frame, and a hybrid altitude ALT_HYB in a terrestrial reference frame. The hybridization computer also supplies one or more protection radius values representing the accuracy of the data originating from the hybridization, in particular a protection radius of the horizontal position and a protection radius of the hybrid altitude.

The hybridization is carried out by Kalman filtering algorithms to obtain both the qualities of stability and of absence of noise in the short term of the inertial unit and the very high but strongly affected by noise accuracy in the short term of the GPS receiver. Kalman filtering is used to take account of the intrinsic behavioral errors of the inertial unit C_INERT and to correct those errors. The measurement error of the inertial unit is determined during the filtering; it is added to the measurement supplied by the unit to give a hybrid measurement in which the errors due to the behavior of the unit are minimized.

The inertial unit thus hybridized is associated with a radiosonde RAD_SONDE and a digital terrain database DTED (initials for “Digital Terrain Elevation Data”) that are intended to improve the accuracy of the hybrid altitude ALT_HYB supplied by the hybridized inertial unit.

The radiosonde supplies a measurement of the aircraft's height HAUT_RAD above the ground at a measurement instant

The terrain database contains the geographic altitudes, in a terrestrial reference frame, of a network of points distributed in the region being overflown by the aircraft during a determined flight. The mesh of this network varies in size depending on the required accuracy. The altitude given for a geographic point is in principle the altitude of the highest point of a square which is centered on this geographic point and the side of which is equal to the spacing of the network. The database can be addressed in horizontal position (longitude and latitude) and supplies an altitude for that position.

The data from the hybrid inertial unit, from the radiosonde and from the terrain database are combined to correct the altitude ALT_HYB supplied by the inertial unit. The corrected altitude ALT_HYB_COR is supplied to the user. The user may be the pilot or a computer.

Computation of the corrected altitude is carried out in the hybridization computer CALC_HYB or in a separate computer. To make FIG. 1 clearly understandable, a separate computer has been shown which receives the data from the radiosonde, from the terrain database and from the hybridization computer and which supplies a corrected altitude ALT_HYB_COR which replaces the hybrid altitude in the hybrid data D_HYB supplied to the user. This computer also supplies the protection radius RPalt_hyb_cor of the corrected altitude.

FIG. 2 represents the principle of computing the corrected altitude.

The hybrid unit supplies a hybrid horizontal position POS_HOR_HYB of the aircraft, in the form of a geographic longitude and latitude. This position is applied as an input to the terrain database DTED. A corresponding altitude of the terrain ALT_GND at this position is supplied.

This altitude ALT_GND is added to the height HAUT_RAD supplied by the radiosonde to provide an altitude of the aircraft in a terrestrial reference frame, ALT_RAD.

ALT_RAD=ALT_GND+HAUT_RAD

At this stage, provision could be made for this altitude ALT_RAD to constitute the corrected altitude which can purely and simply replace the hybrid altitude supplied by the inertial unit. The radiosonde and the database would in this case serve directly to reset the inertial unit instead of the GPS receiver when the latter supplies insufficiently accurate measurements.

However, it is preferable to proceed in a different manner and to smooth the computation of the deviation, by carrying out a digital filtering over a succession of successive measurement samples for which the deviation ΔH(i) is evaluated (the index i representing the sample number) between the altitude ALT_HYB given by the inertial unit and the altitude ALT_RAD given by the radiosonde associated with the terrain database.

ΔH(i)=ALT_{—}RAD(i)−ALT_{—}HYB(i)

In a first variant of embodiment, the deviations are simply averaged over N successive samples. The average is a sliding average, the last N samples being considered each time. An average deviation ΔHm=(1/N) [sum from 1 to N of the ΔH(i)] is computed. It is this average deviation which constitutes the correction value COR_ALT, which is added to the hybrid altitude ALT_HYB to give a corrected altitude ALT_HYB_COR.

ALT_HYB_COR=ALT_HYB+COR_ALT

so here ALT_{—}HYB_{—}COR=ALT_{—}HYB+ΔHm

In a second variant of embodiment, the filtering may be a first-order integrator filtering, in which a feedback loop establishes an altitude correction value COR_ALT by integration of an error signal representing the difference between the altitude ALT_RAD given by the radiosonde and the sum of the hybrid altitude ALT_HYB and of the correction value COR_ALT computed for a previous sample. The error signal therefore represents the difference between the observed deviation and a previously computed altitude correction.

ε=(ALT_{—}RAD)−(ALT_{—}HYB)−(COR_{—}ALT)

In the example shown in FIG. 3, the filtering function is first order (in 1/p if p is the Laplace variable), with a loop gain K, but it could be more complex (second order for example, or more).

An explanation will now be given of how a radius of protection of the corrected altitude measurement can be determined, on the understanding that, in the applications in which the measurements are critical, it is necessary to know this protection radius and to trigger alarms or take piloting decisions according to the value of the computed protection radius.

It is recalled that the radius of protection RP of a measurement, for a predetermined probability of nondetection of error PND, is an upper bound on the deviation between the computed value and the actual value of the magnitude measured, such that there is a probability of less than PND that the actual value is separated from the computed value by a distance greater than RP. There is therefore a maximal probability PND that the actual value is outside a circle of radius RP around the value that has been found by computation, or a maximal probability PND that the actual measurement error exceeds the announced protection radius. This again boils down to saying that there is a maximal probability PND of being mistaken in the determination of the protection radius.

Usually, the maximal probability PND is set to suit the application. In the example of landing an aircraft, for example, a maximal probability PND of 10⁻⁷/hour of making a mistake regarding the protection radius due to a foreseeable or unforeseeable fault may be required.

Now, the protection radius is directly related to the variance of the magnitude measured (or its standard deviation) and to the probability of nondetection of error PND. The variance is the square of the standard deviation Σ related to the magnitude measured.

The protection radius RP is related to the standard deviation Σ and the probability of nondetection PND via the following approximate table,

| PND value | RP value |
|---|---|
| 0.35/hour | Σ |
| 5.10⁻²/hour | 2 Σ |
| 10⁻³/hour | 3 Σ |
| 10⁻⁷/hour | 5.7 Σ |
| 10⁻⁹/hour | 7 Σ |

According to the probability of nondetection that is set (and therefore according to the application envisaged), a coefficient k can therefore be determined such that the protection radius RP is equal to kΣ. The coefficient k takes a value between 1 and 7 in the above table.

This protection radius is computed based on the standard deviations of the variables in question. It applies to each possible variable, but in practice the thing of interest here is the distance variables.

A protection radius computation is carried out in the hybridization computer, in the presence of errors modeled in the Kalman filter. This computation involves in particular the variances taken from the covariance matrix of the Kalman filter. The square root of each variance gives a standard deviation. The standard deviation is used to determine a protection radius. The protection radius computation may be more complex than a simple multiplication of the standard deviation by a coefficient k; this is particularly the case when seeking to determine a protection radius in the presence of a satellite failure in the GPS receiver. In this case, supposing that a protection radius has been computed for a probability of nondetection PND corresponding to a factor k in the above table, it will be considered as a hypothesis that the position variable assigned by this protection radius RP is a variable whose supposed standard deviation is RP/k.

FIG. 4 represents the protection radius computation that is carried out according to the invention.

The hybrid inertial unit supplies a protection radius RPpos_hor_hyb for the hybrid horizontal position measurement and a protection radius RP_alt_hyb for the hybrid altitude measurement.

The altitude protection radius RP_alt_hyb is associated with a standard deviation Σalt_hyb by simply dividing the protection radius by a factor k=k1 corresponding to the probability of nondetection that is set. Take for example k1=5.7 for a probability of 10⁻⁷/hour.

Σalt_{—}hyb=(RP_{—}alt_{—}hyb)/k1

Furthermore, a standard deviation Σalt_rad of the altitude measurement RAD_ALT supplied by the radiosonde associated with the terrain database is computed. This standard deviation results from three parameters: the inaccuracy specific to the radiosonde, expressed in the form of a standard deviation Σhaut-rad; the inaccuracy specific to the terrain database DTED, also expressed in the form of a standard deviation Σdetd; and a dispersion of ground altitudes that exists in the region surrounding the position of the aircraft, this dispersion again being expressed in the form of a standard deviation Σdisp.

If the inaccuracy of the radiosonde is for example 1% and the height it supplies is 1000 meters, it will be considered that the standard deviation Σhaut-rad is 10 meters.

The inaccuracy of the terrain altitude supplied by the database is given by the producer of that database. It may depend on the region in question and on the resolution of the mesh of the base.

The standard deviation of dispersion of terrain altitudes in the region being overflown is computed based on the horizontal protection radius RPpos_hor_hyb supplied by the hybrid inertial unit. For this, we determine, for each mesh cell of the terrain database, within a zone surrounding the horizontal position POS_HOR_HYB supplied by the inertial unit, the deviation between the altitude of the ground in this mesh cell and the altitude ALT_GND corresponding to the horizontal position of the aircraft.

FIG. 5 represents the zone in which these deviations are computed; this zone is determined based on the horizontal protection radius. It may be defined by a circle centered on the horizontal position POS_HOR_HYB and having as its radius the protection radius RPpos_hor_hyb given by the inertial unit for the horizontal position; the dashed circle in FIG. 5 represents this zone.

However, account may also be taken in this computation of the fact that usually a radiosonde transmits a radio frequency wave that is not along a vertical axis (which would give the height above the ground exactly) but along a cone of vertical axis (the aircraft being assumed to be horizontal) and with a spread of approximately 45°. This cone introduces a certain degree of uncertainty concerning the distance between the aircraft and an obstacle on the ground situated at this distance D; the obstacle is indeed at distance D, but the aircraft is not necessarily situated at a height D above that obstacle if the obstacle is not vertically beneath the aircraft.

For this reason, it will be preferable to compute the dispersion of terrain altitudes within a circle the radius of which is not the protection radius RPpos_hor_hyb but the sum of this radius and of a radius Rcone corresponding to the radius of the circle of illumination of the ground by the radiosonde. If the angle of the cone of illumination is 2a, the radius Rcone is (HAUT_RAD)tana.

The circle of radius [(RPpos_hor_hyb)+Rcone] is represented in solid lines in FIG. 5.

Inside the circle thus defined based on the protection radius and where necessary on the height HGAUT_RAD given by the radiosonde, all the deviations between the altitude of the ground (ALT_GND) at the position of the aircraft and the altitude of the ground at the neighboring points are calculated. The quadratic average of these deviations is computed to define a standard deviation Σdisp representing the altitude dispersion of the ground inside this circle.

With the three standard deviations Σhaut_rad, Σdted and Σdisp, a global standard deviation Σalt_rad of the altitude measurement supplied by the radiosonde associated with the terrain database is computed. This standard deviation is the quadratic sum of the previous three deviations, that is the square root of [(Σhaut_rad)²+(Σdted)²+(Σdisp)²].

(Σalt_{—}rad)²=(Σhaut_{—}rad)²+(Σdted)²+(Σdisp)²

In the same manner, the standard deviation ΣΔH of the deviation ΔH between the altitude supplied by the inertial unit and the altitude supplied by the radiosonde is the quadratic sum of the standard deviation Σalt_hyb of the inertial unit and the standard deviation Σalt_rad of the altitude supplied by the radiosonde.

(ΣΔH)²=(Σalt_{—}hyb)²+(Σalt_{—}rad)²

But to compute the average deviation between these altitudes, it is recalled that this deviation is averaged or filtered, thereby greatly reducing the standard deviation of the altitude correction. The standard deviation of the corrected altitude is the same as the standard deviation of the altitude correction, the uncertainty concerning the hybrid altitude already having been taken into account.

If the altitude correction COR_ALT is the sliding average over the previous N samples of the deviation between the two altitudes, it can be said that the standard deviation Σalt_hyb_cor of the corrected altitude ALT_HYB^{—}COR, equal to the standard deviation Σcor_alt of the correction COR_ALT, is the standard deviation ΣΔH divided by the square root of the number of samples taken into account in the average.

(Σalt_{—}hyb_{—}cor)²=(Σcor_{—}alt)²=(ΣΔH)²/N

This standard deviation is considerably less than the standard deviation of the altitude information given by the hybrid unit when the number of samples is sufficiently high.

Based on this standard deviation, a protection radius RPalt_hyb_cor of the corrected altitude can be computed. The protection radius is equal to the standard deviation multiplied by the coefficient k corresponding to the required probability of nondetection.

When the average of the deviations between the two altitudes is computed, it is also possible to check on the fact that the samples of altitude deviation ΔH(i) obey a predictable statistical law and to trigger an alarm if they do not. In this manner, a check is made of the consistency of the indications supplied by the inertial unit and by the radiosonde. For this, a quadratic average of the deviations is calculated, normed by their respective standard deviations, over N successive samples of deviation measurement.

If i represents the index of a sample, the deviation ΔH(i) for a given sample is divided by the corresponding standard deviation ΣΔH(i). The ratio between the measured deviation and the standard deviation should be a variable that obeys a Khi² law with N degrees of freedom, in consequence of which, compliance with this law is checked by first computing the quadratic average of this ratio, over N samples, and by comparing this average with a threshold. This threshold is determined as a function of the number N of samples and as a function of an accepted false alarm rate.

The computed quadratic average is the square root of the following expression: (1/N){sum of the N values [ΔH(i)/ΣΔH(i)]²}.

If the altitude correction is made by digital filtering of the observed deviations, rather than by averaging, it is understood that a standard deviation of the corrected value may also be defined, this being less than the standard deviation of the altitude supplied by the inertial unit when the feedback loop which computes the correction converges to a stable situation. The standard deviation of the corrected value is determined based on the variance of the deviation ΔH observed between the two altitude measurements. This variance may be computed as is done in Kalman filtering based on the propagation matrix of the variances which describes the filtering loop used.

The invention has been described with a single radiosonde, but it goes without saying that several radiosondes could be used to reduce the risk of faults due to hardware failures of the radiosonde.

1. An onboard navigation aid system in an aircraft, comprising:
an inertial navigation unit (C_INERT) supplying a horizontal position and an altitude (ALT_HYB) in a terrestrial reference frame,
means (RAD_SONDE) for supplying a measurement of the height (HAUT-RAD) of the aircraft relative to the ground;
a terrain database supplying an altitude of the ground corresponding to the horizontal position delivered by the inertial unit;
means for correcting the altitude supplied by the inertial unit by using the data originating from the means for supplying the height and the terrain database; comprising:
means for supplying a radius of protection associated with the horizontal position supplied by the inertial unit;
computing means supplying a radius of protection associated with the corrected altitude, means for computing a dispersion of the altitude of the ground as contained in the terrain database, within a limited zone of terrain centered on the horizontal position supplied by the inertial unit.

2. The system as claimed in claim 1, wherein the altitude dispersion is computed in a zone the radius of which is defined based on the radius of protection of the horizontal position.

3. The system as claimed in claim 2, wherein the altitude dispersion is computed in a zone the radius of which is the sum of the radius of protection of the horizontal position and of a value representing an inaccuracy of measurement of the means for supplying the height, this value preferably being the radius of a circle of radio illumination of the ground by the radiosonde in the case where the means for supplying the height is radiosonde.

4. The system as claimed in claim 1, wherein the means of computing the radius of protection of the corrected altitude comprise a means of computing a quadratic sum of a standard deviation (Σalt_rad) linked to the computation of the sum of the height relative to the ground (HAUT_RAD) and of the altitude of the ground (ALT_GND) and of a standard deviation (Σalt_hyb) linked to the altitude originating from the inertial unit. (ALT_HYB), and a means for computing a standard deviation and a radius of protection of the corrected altitude, based on the quadratic sum computed and averaged over N successive measurement samples.

5. The system as claimed in claim 4, wherein the standard deviation linked to the computation of the sum of the height relative to the ground and of the altitude of the ground is the quadratic average of several standard deviations including a standard deviation (Σdisp) representing the altitude dispersion of the ground.

6. The navigation aid system as claimed in claim 1, wherein it comprises means for computing a deviation (ΔH) between the altitude (ALT_HYB) delivered by the inertial unit and an altitude (ALT_RAD) computed based on the height (HAUT_RAD) supplied by the radiosonde and on an altitude of the ground (ALT_GND) generated from the terrain database.

7. The system as claimed in claim 6, wherein the means of computing the deviation (ΔH) comprise means for subtracting the altitude supplied by the inertial unit from the sum of the height (HAUT_RAD) supplied by the radiosonde and of the ground altitude (ALT_GND) supplied by the database for the horizontal position supplied by the unit.

8. The system as claimed in claim 7, wherein it comprises computing means for smoothing the value of the deviation (ΔH) over several measurements corresponding to several successive values of position and of altitude supplied by the inertial unit.

9. The system as claimed in claim 8, wherein the smoothing means comprise means for computing the sliding average of N successive deviations (ΔH(i)) corresponding to N successive altitudes supplied by the inertial unit, and means for adding the sliding average to the current altitude (ALT_HYB) supplied by the inertial unit, to give a corrected altitude (ALT_HYB_COR).

10. The system as claimed in claim 9, wherein the smoothing means comprise a digital filtering loop establishing an altitude correction value (COR_ALT) by integration of an error signal (ε) representing the difference between the deviation (ΔH) and the altitude correction originating from the loop for a previous measurement.

11. The system as claimed in claim 1, wherein the inertial unit is a unit hybridized with a satellite positioning receiver.

12. An onboard navigation aid system in an aircraft, comprising:
an inertial navigation unit (C_INERT) supplying a horizontal position and an altitude (ALT_HYB) in a terrestrial reference frame,
means (RAD_SONDE) for supplying a measurement of the height (HAUT_RAD) of the aircraft relative to the ground,
a terrain database supplying an altitude of the ground corresponding to the horizontal position delivered by the inertial unit,
means for correcting the altitude supplied by the inertial unit by using the data originating from the means for supplying the height and the terrain database,
means for supplying a radius of protection associated with the horizontal position supplied by the inertial unit;
computing means supplying a radius of protection associated with the corrected altitude;
means for computing a dispersion of the altitude of the ground as contained in the terrain database, within a limited zone of terrain centered on the horizontal position supplied by the inertial unit.

13. The system as claimed in claim 12, wherein the altitude dispersion is computed in a zone the radius of which is defined based on the radius of protection of the horizontal position.

14. The system as claimed in claim 13, wherein the altitude dispersion is computed in a zone the radius of which is the sum of the radius of protection of the horizontal position and of a value representing an inaccuracy of measurement of the means for supplying the height, this value preferably being the radius of a circle of radio illumination of the ground by the radiosonde in the case where the means for supplying the height is radiosonde.

15. The system as claimed in claim 12, wherein the means of computing the radius of protection of the corrected altitude comprise a means of computing a quadratic sum of a standard deviation (Σalt_rad) linked to the computation of the sum of the height relative to the ground (HAUT_RAD) and of the altitude of the ground (ALT₁₃ GND) and of a standard deviation (Σalt_hyb) linked to the altitude originating from the inertial unit (ALT_HYB), and a means for computing a standard deviation and a radius of protection of the corrected altitude, based on the quadratic sum computed and averaged over N successive measurement samples.

16. The system as claimed in claim 15, wherein the standard deviation linked to the computation of the sum of the height relative to the ground and of the altitude of the ground is the quadratic average of several standard deviations including a standard deviation (Σdisp) representing the altitude dispersion of the ground.

17. The navigation aid system as claimed in claim 12, wherein it comprises means for computing a deviation (ΔH) between the altitude (ALT_HYB) delivered by the inertial unit and an altitude (ALT_RAD) computed based on the height (HAUT_RAD) supplied by the radiosonde and on an altitude of the ground (ALT_GND) generated from the terrain database.

18. The system as claimed in claim 17, wherein the means of computing the deviation (ΔH) comprise means for subtracting the altitude supplied by the inertial unit from the sum of the height (HAUT_RAD) supplied by the radiosonde and of the ground altitude (ALT_GND) supplied by the database for the horizontal position supplied by the unit.

19. The system as claimed in claim 18, wherein it comprises computing means for smoothing the value of the deviation (ΔH) over several measurements corresponding to several successive values of position and of altitude supplied by the inertial unit.

20. The system as claimed in claim 19, wherein the smoothing means comprise means for computing the sliding average of N successive deviations (ΔH(i)) corresponding to N successive altitudes supplied by the inertial unit, and means for adding the sliding average to the current altitude (ALT_HYB) supplied by the inertial unit, to give a corrected altitude (ALT_HYB_COR).

21. The system as claimed in claim 20, wherein the smoothing means comprise a digital filtering loop establishing an altitude correction value (COR_ALT) by integration of an error signal (Σ) representing the difference between the deviation (ΔH) and the altitude correction originating from the loop for a previous measurement.

22. The system as claimed in claim 12, wherein the inertial unit is a unit hybridized with a satellite positioning receiver.
